(19) United States
(12) Patent Application Publication
(10) Pub. No.: US 2014/0261025 A1
(43) Pub. Date: Sep. 18, 2014

(54) Card Printing and Protection Method and System

(71) Applicant: ILLINOIS TOOL WORKS INC., Glenview, IL (US)

(72) Inventors: Frank J. Olsen, JR., Stratham, NH (US); John H. Schneider, Frankfort, IL (US)

(73) Assignee: ILLINOIS TOOL WORKS INC., Glenview, IL (US)

(21) Appl. No.: 13/842,759

(22) Filed: Mar. 15, 2013

(51) Int. Cl. B41F 19/02

(52) U.S. Cl. CPC B41F 19/02
USPC 101/27; 101/32

(57) ABSTRACT

A method and system for card printing and protection provides for single step construction of a card having an image and a protective overlay. A blank card is fed into a hot stamp module, through which is also fed a supply of overlay or patch film. A thermal transfer printer prints an image onto the overlay or patch before it enters the hot stamp module. The blank card is registered with the printed overlay or patch and then hot stamped together to create the finished card construction. A security printing/application module can also selectively apply a security feature or element to the overlay or patch before it enters the hot stamp module.

### TECHNICAL FIELD

The exemplary teachings herein pertain to methods and techniques for printing and protecting financial, transactional, identification and other security cards or the like, and in particular, to a process of producing a protected card with an image. Specifically, the present disclosure relates to a process for the single step construction of a card having an image and a protective overlay, and to the products made by the process.

### BACKGROUND

Standard card printing technology typically involves first printing the card with personalized information and photographs via, dye diffusion thermal transfer (D2T2) printing on card personalization machines. The cards are then protected by the application of an overlay or a patch. This application is done in a second step. The major drawback to this method is that resolution is limited. With increasing security concerns, the market, especially the personal identification market, needs increased resolution that the typical dye diffusion thermal transfer printing method cannot provide.

FIG. 1 illustrates this standard card printing technology. As can be seen from right to left in the drawing, a blank card is first fed to a thermal transfer printer. An image is formed by the printer on the card using a D2T2 ribbon as is known in the art. The printed card is next fed to a hot stamp module. A protective overlay or patch is applied to the card using a protective overlay or patch transfer film as is known in the art. This two-step process produces the finished card, but uses more film and more process steps, and has limited resolution.

A more recent card printing technology involves an intermediate transfer method. In this method, a release film is provided. It is printed via dye diffusion thermal transfer printing and then is indexed through the machine to a point where the image is hot stamped onto the card. Subsequently, the cards are protected by the applications of an overlay or patch. As above, this application is done in a second step.

FIG. 2 illustrates this more recent card printing technology. As can be seen from right to left in the drawing, a blank card is first fed to a hot stamp module. An image is formed on an intermediate transfer film or release film via a thermal transfer printer using a D2T2 ribbon as is known in the art. The image printed on the intermediate transfer film or release film is then hot stamped onto the card by the hot stamp module, as is known in the art. The card is next fed to another hot stamp module. A protective overlay or patch is applied to the card using a protective overlay or patch transfer film as is known in the art. As before, this more recent two-step process produces the finished card, but uses more film and more process steps, and has limited resolution.

Therefore, a need exists for an improved method of printing and protecting card substrates, which is directed toward overcoming these and other disadvantages of prior art methods. Accordingly, to address the above stated issues, an improved method for printing and protecting financial, transactional, identification and other security cards is needed. The exemplary teachings herein fulfill such a need. It is desired that the methods and techniques for providing the above benefits be applicable to any instances or applications wherein images are to be printed on a substrate and protected.

### SUMMARY

The exemplary technique(s), system(s) and method(s) presented herein provide for a finished card construction, having an image and a protective overlay, through a single step process. An overlay transfer film or a web containing a patch is fed into the dye diffusion thermal transfer print module. The overlay or patch is printed with the personalized image via dye sublimation thermal transfer printing. The printed overlay or patch is then indexed though the machine to a point where the image and the protective layer are hot stamped or heat transferred to the card in a single step.

The disclosed methods and techniques eliminate the separate intermediate transfer film used by the more recent card printing technology discussed above, resulting in reduced process steps and costs. Further, the disclosed process uses less film to produce a personalized card and thus is more sustainable. Also, higher resolution images can be obtained.

Additional objects, advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawing figures depict one or more implementations in accordance with the present teachings, by way of example only, not by way of limitation. In the drawing figures, like reference numerals refer to the same or similar elements.

FIG. 1 is a schematic diagram of a standard prior art card printing and protection process;

FIG. 2 is a schematic diagram of a more recent prior art card printing and protection process; and

FIG. 3 is a schematic diagram of an exemplary embodiment of a card printing and protection process and system according to the present disclosure.

### DETAILED DESCRIPTION

The following description refers to numerous specific details which are set forth by way of examples to provide a thorough understanding of the relevant teachings. It should be apparent to those skilled in the art that the present teachings may be practiced without such details. In other instances, well known methods, procedures, and components have been described at a relatively high-level, without detail, in order to avoid unnecessarily obscuring aspects of the present teachings.

Referring now to FIG. 3, a preferred embodiment of the disclosed teachings is illustrated. As can be seen from the drawing, a blank card is fed in a first direction indicated by the card feed direction arrow, to a hot stamp module through which is fed an overlay or patch film in a second direction opposite that of the card feed direction. An image is formed on the overlay or patch via, a thermal transfer printer, using D2T2 or thermal transfer ribbon (TTR) (not shown) prior to entering the hot stamp module. Optionally, a security printing/application module can also print or apply security elements or features onto the overlay or patch. For example, these other security elements or features include, but are not limited to, chemical taggants, UV fluorescing dyes, security inks, forensic markers, RFID antennae, RFID chips, and other known security features and elements.

The printed overlay or patch is then indexed or registered with the blank card stock in the hot stamp module, at which time it is hot stamped onto the card by the hot stamp module to produce the finished, printed card. Accordingly, a single step, card printing and protection method is realized.

As illustrated in FIG. 3, the layout of the disclosed system includes an initial supply of the overlay or patch film, in roll form, which extends around two intermediate rollers before returning to a spent film take-up roller. The hot stamp module is located between the two intermediate rollers. The D2T2 and/or TTR printing module is located between the initial supply of the overlay or patch film and the first intermediate roller, i.e., the one closest to the initial supply. The optional security printing/application module is also located between the initial supply of the overlay or patch film and the first intermediate roller. This could be on either side of the D2T2 and/or TTR printing module.

While the foregoing discussion presents the teachings in an exemplary fashion with respect to the disclosed methods and techniques for card printing and protection, and the products produced by the methods and techniques, it will be apparent to those skilled in the art that the teachings may apply to any type of card printing and protection system that requires multiple steps to produce the finished card. Further, while the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed is:

1. A process for card printing and protection, comprising the steps of:
feeding a blank card to a hot stamp module;
printing an image on an overlay or patch;
feeding the printed overlay or patch to the hot stamp module; and
hot stamping the printed overlay or patch to the card.

2. The process of claim 1, further including the step of applying security elements or features on the overlay or patch.

3. The product made by the process of claim 3.

4. A system for card printing and protection comprising:
a hot stamp module for receiving a blank card;
an overlay or patch selectively fed through the hot stamp module; and
a printing module for printing an image onto the overlay or patch to produce a printed overlay or patch;
wherein the hot stamp module hot stamps the printed overlay or patch to the blank card to produce a finished card.

5. The system of claim 4 further comprising:
a security application module for applying a security element or feature onto the overlay or patch.
